(19) United States
(12) Patent Application Publication
(10) Pub. No.: US 2022/0281336 A1
(43) Pub. Date: Sep. 8, 2022

(54) METHOD, APPARATUS, AND COMPUTER-READABLE STORAGE MEDIUM FOR ALIGNING A VEHICLE TO BE CHARGED RELATIVE TO A VEHICLE CHARGING STATION

(71) Applicant: VALEO NORTH AMERICA, INC., Troy, MI (US)

(72) Inventors: Mirian RODRIGUEZ ROMERO, Birmingham, MI (US); Ovidiu BUZDUGAN ROMCEA, Birmingham, MI (US)

(73) Assignee: VALEO NORTH AMERICA, INC., Troy, MI (US)

(21) Appl. No.: 17/191,489

(22) Filed: Mar. 3, 2021

(51) Int. Cl. B60L 53/36; B60L 53/37; G01C 21/34; G01C 21/36; G06F 3/0484; G06F 3/0481; G06T 7/70; G06K 9/00

(52) U.S. Cl. CPC B60L 53/36; B60L 53/37; G01C 21/3407; G01C 21/3679; G01C 21/3626; G06F 3/04842; G06F 3/0481; G06T 7/70; G06K 9/00791; B60L 53/14

(57) ABSTRACT

Method, apparatus, and computer-readable medium for aligning a vehicle to be charged relative to a vehicle charging station. A method, comprising detecting, within an image of the vehicle charging station, one or more identifiers corresponding to one or more charging units supported by the vehicle charging station, each charging unit comprising a different charging mechanism, determining, using the one or more identifiers, locations of the one or more charging units relative to the vehicle, and types of the one or more charging units, determining, based on a selection of a compatible one of the one or more charging units, a target charging position of the vehicle corresponding to the selected compatible charging unit, and generating, based on the target charging position of the vehicle, a vehicle trajectory for maneuvering the vehicle between a current position of the vehicle and the target charging position of the vehicle.

### BACKGROUND

### Field of the Disclosure

The present disclosure relates to detecting a vehicle charging station, its relative position to a vehicle, and aligning a charging element of the vehicle with a charging element of the vehicle charging station.

### Description of the Related Art

Efforts have been made to aid drivers of electric vehicles in ensuring optimal charging upon arrival at vehicle charging stations. However, current approaches do not account for multiple types of charging units (e.g., wireless charging unit, robot arm unit, etc.) that may each provide varying levels of charging efficiency and/or compatibility with the vehicle to be charged. Thus, it can be appreciated that a precise and flexible approach to vehicle charging alignment has yet to be developed.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present invention.

### SUMMARY

The present disclosure relates to a method, apparatus, and computer-readable storage medium for detecting and aligning a vehicle to be charged with a vehicle charging station.

According to an embodiment, the present disclosure further relates to a method for aligning a vehicle to be charged relative to a vehicle charging station, comprising detecting, by a processing circuitry and within an image of the vehicle charging station, one or more identifiers corresponding to one or more charging units supported by the vehicle charging station, each charging unit comprising a different charging mechanism, determining, by the processing circuitry and using the one or more identifiers, locations of the one or more charging units relative to the vehicle, and types of the one or more charging units, determining, by the processing circuitry and based on a selection of a compatible one of the one or more charging units, a target charging position of the vehicle corresponding to the selected compatible charging unit, and generating, by the processing circuitry and based on the target charging position of the vehicle, a vehicle trajectory for maneuvering the vehicle between a current position of the vehicle and the target charging position of the vehicle.

According to an embodiment, the present disclosure further relates to a non-transitory computer-readable storage medium storing computer-readable instructions that, when executed by a computer, cause the computer to perform a method for aligning a vehicle to be charged relative to a vehicle charging station, comprising detecting, within an image of the vehicle charging station, one or more identifiers corresponding to one or more charging units supported by the vehicle charging station, each charging unit comprising a different charging mechanism, determining, using the one or more identifiers, locations of the one or more charging units relative to the vehicle, and types of the one or more charging units, determining, based on a selection of a compatible one of the one or more charging units, a target charging position of the vehicle corresponding to the selected compatible charging unit, and generating, based on the target charging position of the vehicle, a vehicle trajectory for maneuvering the vehicle between a current position of the vehicle and the target charging position of the vehicle.

According to an embodiment, the present disclosure further relates to an apparatus for aligning a vehicle to be charged relative to a vehicle charging station, comprising processing circuitry configured to detect, within an image of the vehicle charging station, one or more identifiers corresponding to one or more charging units supported by the vehicle charging station, each charging unit comprising a different charging mechanism, determine, using the one or more identifiers, locations of the one or more charging units relative to the vehicle, and types of the one or more charging units, determine, based on a selection of a compatible one of the one or more charging units, a target charging position of the vehicle corresponding to the selected compatible charging unit, and generate, based on the target charging position of the vehicle, a vehicle trajectory for maneuvering the vehicle between a current position of the vehicle and the target charging position of the vehicle.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustration of a vehicle, according to an exemplary embodiment of the present disclosure;

FIG. 2 is a flow diagram of a method for aligning a vehicle to be charged relative to a vehicle charging station, according to an exemplary embodiment of the present disclosure;

FIG. 3A is a flow diagram of a sub process of a method for aligning a vehicle to be charged relative to a vehicle charging station, according to an exemplary embodiment of the present disclosure;

FIG. 3B is a flow diagram of a sub process of a method for aligning a vehicle to be charged relative to a vehicle charging station, according to an exemplary embodiment of the present disclosure;

FIG. 4A is a flow diagram of a sub process of a method for aligning a vehicle to be charged relative to a vehicle charging station, according to an exemplary embodiment of the present disclosure;

FIG. 4B is a flow diagram of a sub process of a method for aligning a vehicle to be charged relative to a vehicle charging station, according to an exemplary embodiment of the present disclosure;

FIG. 4C is a flow diagram of a sub process of a method for aligning a vehicle to be charged relative to a vehicle charging station, according to an exemplary embodiment of the present disclosure;

FIG. 4D is a flow diagram of a sub process of a method for aligning a vehicle to be charged relative to a vehicle charging station, according to an exemplary embodiment of the present disclosure;

FIG. 5 is a flow diagram of a sub process of a method for aligning a vehicle to be charged relative to a vehicle charging station, according to an exemplary embodiment of the present disclosure;

FIG. 6A is an illustration of an implementation of a method for aligning a vehicle to be charged relative to a vehicle charging station, according to an exemplary embodiment of the present disclosure;

FIG. 6B is an illustration of an implementation of a method for aligning a vehicle to be charged relative to a vehicle charging station, according to an exemplary embodiment of the present disclosure;

FIG. 7 is a flow diagram of an implementation of a method for aligning a vehicle to be charged relative to a vehicle charging station, according to an exemplary embodiment of the present disclosure;

FIG. 8 is a schematic illustrating the communication architecture of a system including a vehicle wherein processing is performed remotely, according to an exemplary embodiment of the present disclosure; and

FIG. 9 is a block diagram of a vehicle control system, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Efforts to aid vehicle alignment with charging stations may include alignment aids that help the driver to navigate the vehicle to a target charging position. Often, display graphics, or visual overlays, are positioned relative to wireless charging pads, and the like, and the alignment procedure includes the driver using the display graphics to maneuver the vehicle towards the target vehicle position by adjusting the steering wheel angle and braking. In other situations, wherein an articulated robot arm is used, for instance, there are few automated functions related to alignment. In these cases, the driver is assumed to have better visual perception of the charging element at the vehicle charging station and can better position their vehicle relative to the charging element.

Of course, these approaches not only rely on the driver to maneuver the vehicle. These approaches also rely on the use of a data display graphic, though this data display graphic often present limited data that does not convey enough information for the vehicle to be precisely positioned. For instance, by merely demarcating a general target location for the driver, it is impossible to ensure the vehicle is positioned exactly where needed for high efficiency charging.

In an embodiment, the present disclosure describes methods for improving vehicle alignment by automating recognition of varying vehicle charging units and maneuvering the vehicle based on an estimated location and type of the vehicle charging units.

According to an embodiment, the present disclosure employs a computer vision algorithm for estimating a location of a vehicle charging unit based on a detected identifier located at the vehicle charging station and corresponding to the vehicle charging unit. In an embodiment, the detected identifier may be a graphical pattern (e.g. QR code) disposed on the vehicle charging station. In an embodiment, the computer vision algorithm can estimate the location of the detected identifier based on images of the vehicle charging station. In another embodiment, the computer vision algorithm may be bypassed and the detection of the identifier may include, via implementation of an image classification algorithm, or other computer vision algorithm, receiving information stored within or associated with the detected identifier regarding the type and location of the vehicle charging unit.

According to an embodiment, the present disclosure may employ a computer vision algorithm for estimating a type of the vehicle charging units available at the vehicle charging station. In this way, a type of adaptive alignment may be provided based on the type of vehicle charging units estimated by the computer vision algorithm.

In an embodiment, a first computer vision algorithm may be applied to acquired images of the vehicle charging station, the first computer vision algorithm detecting identifiers therein. In one instance, detected identifiers may be located in three-dimensional (3D) space, and the location thereof, relative to the vehicle, may serve as charging positions for corresponding charging units. For example, the location of a detected identifier may be collocated with a corresponding charging unit when the corresponding charging unit is a wireless charging unit. In another instance, the detected identifiers may include information regarding the position of the charging station and/or corresponding charging units relative to the identifier. In other words, though a detected identifier does not have to be collocated with a charging position, the detected identifier conveys information relevant to determining a target alignment position of the vehicle. A second computer vision algorithm may then be applied to regions of interest of the acquired images of the vehicle charging station in order to determine a type of the corresponding charging units, the regions of interest being limited to regions of the images proximate to the detected and located identifiers.

In another embodiment, in the event a first computer vision algorithm is used to locate the identifier, a second computer vision algorithm can be applied to determine the type of vehicle charging units available, the second computer vision algorithm being applied to only a subset of images, or regions of interest of the images, of the vehicle charging station proximate to the located identifier.

Typically, relevant systems detect specific visual patterns to determine a general position of a vehicle charging station. In addition to lacking precision, detection based only a visual pattern does not allow for a determination of whether the vehicle charging station supports plug-in charging (e.g., wall-mounted robot arm, mobile-mounted plug-in charging unit) or wireless charging (e.g., inductive charging unit). As a result, especially when the vehicle to be charged has the ability to receive charge by more than one charging mechanism, it becomes difficult to identify proper alignment of the vehicle based on what charging mechanisms the vehicle charging station supports.

Accordingly, the present disclosure provides a flexible system that can adjust a positioning of a vehicle to be charged based on a graphical pattern and in view of a type of charging unit available.

In an embodiment, the flexible system includes an apparatus, method, and non-transitory computer-readable storage medium for aligning a vehicle to be charged with to a vehicle charging station. The methods described herein include implementation of a first computer vision algorithm configured to detect a position (i.e., x-coordinate, y-coordinate, z-coordinate, angle, and the like) of a graphical patterns (e.g., a QR code or any other type of code), corresponding to a respective charging units, disposed on a vehicle charging station, implementation of a second computer vision algorithm configured to identify a type of the respective charging unit at the vehicle charging station, and implementation of a path planning module configured to calculate a vehicle trajectory toward a charging position based on the location and the type of the respective charging unit. The computer vision algorithms may employ techniques for image classification, object detection, object tracking, and the like. The first computer vision algorithm configured to detect the position of the graphical pattern may employ 3D vision algorithms or other artificial intelligence-based approaches (e.g., convolutional neural networks). Similarly, the second computer vision algorithm configured to detect which types of charging units are supported by the vehicle charging station (e.g., plug-in, wireless charging, and the like) may employ 3D vision algorithms or other artificial intelligence-based approaches (e.g., convolutional neural networks). The path planning module may employ the location and the detected type of charging unit to generate a trajectory between a current position of the vehicle and a target charging position of the vehicle. In an example, the target charging position of the vehicle is coincident with a location of the detected graphical pattern. In another example, the target charging position of the vehicle is based on the location of the detected graphical pattern and the detected type of charging unit available. For instance, the detected type of charging unit available may dictate that a target charging position is at a pre-defined distance relative to the location of the detected graphical pattern. In another example, the detected graphical pattern conveys information about a position of a target charging position, the information being defined relative to a global coordinate system and/or relative to the charging station. Based on the type of charging unit available, the target charging position may be further modified according to user preferences. For instance, the charging unit may be a plug-in (e.g., wall-mounted robot charging arm) and the charging position of the vehicle may be provided in view of a predefined range of lateral movement to account for the user exiting the vehicle in view of the flexibility of the wall-mounted robot charging arm.

In an embodiment, the methods described herein further include implementation of a collision avoidance module, whereby vehicle sensors are utilized to acquire data that can be evaluated in order to prevent collision with obstacles or objects. The sensing and data processing can be performed before and during actualization of the vehicle trajectory determined via the path planning module.

In another embodiment, and assuming the vehicle charging station only supports a single charging unit, the vehicle charging station may have a specific shape, image, or graphical pattern disposed thereon that, upon detection by a computer vision algorithm, indicates a location and a type of charging unit supported by the vehicle charging station. The computer vision algorithm may be a semantic segmentation algorithm or region-based convolutional neural network that evaluates the images of the vehicle charging station and can determine the location and the type of the charging unit based on a classification of regions of the images.

In an embodiment, the vehicle charging station may be configured to be in wireless communication with a mobile device of a user of a vehicle in order to provide information regarding the charging unit(s) supported by the vehicle charging station and a target charging position.

In an embodiment, the graphical pattern, specific shape, or image disposed on the vehicle charging station may be detected by a camera-based algorithm such as an image classification technique and/or a semantic segmentation technique. The camera-based algorithm may be implemented according to images acquired by one or more cameras positioned around an exterior of the vehicle. In an example, the one or more cameras may be a single camera arranged to capture an image including the vehicle charging station. If acquired over time, chronologically-acquired images will provide a pseudo-3D scene that can be used for locating the vehicle.

The methods described herein can be appreciated further when it is understood that prior approaches to vehicle alignment only provide the vehicle with relative coordinates of a vehicle charging station. The present disclosure describes, however, an approach that considers types of charging units supported by the vehicle charging station and accounts for varying alignment requirements and modifications based on the types of the charging units.

In an embodiment, the present disclosure describes a method that allows for, when the charging unit is determined to be a wall-mounted robot charging arm or mobile-mounted plug-in charging unit, slight adjustments to a charging position of the vehicle to be charged in order to allow the user physical space to exit and enter the vehicle. The slight adjustments may be instructions from the user based on a location of a charging unit in view of space restrictions around a user door. This adaptability relies on the flexibility of the wall-mounted robot charging arm or the mobile-mounted plug-in charging unit to accommodate, within predefined ranges of mobility, the positioning of the vehicle to be charged.

In an embodiment, the user may indicate a slight modification to a charging position via a human machine interface, or user interface, of the vehicle to be charged. The instruction may also be provided by a mobile device such as a smartphone and the like. In the event the charging unit is a wall-mounted robot charging arm, the user may request a lateral offset of 0.5 meters from a charging position dictated according to the detection and localization of the identifier. 0.5 meters is, of course, exemplary of a variety of possible movements instructed by the user. Each of the movements, however, is based on predefined ranges, or tolerances, based on the type of charging unit.

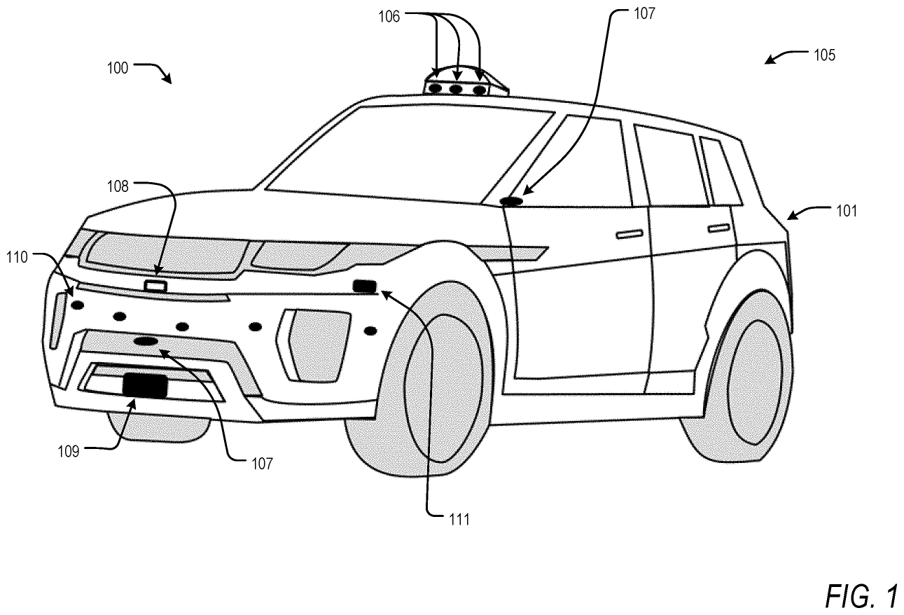

With reference now to the Figures, FIG. 1 is an illustration of a semi-autonomous vehicle (SAV), according to an exemplary embodiment of the present disclosure. Though it can be appreciated that any vehicle may be used in view of the methods described herein, including those with only minimal levels of autonomy and up to those that may be fully autonomous, an SAV will be described, for simplicity. The SAV 100 may perform the methods introduced above and described below. The methods may be performed entirely by the SAV 100, by the SAV 100 and third party equipment installed within the SAV 100, by a remote server in communication with the SAV 100, or other combinations thereof.

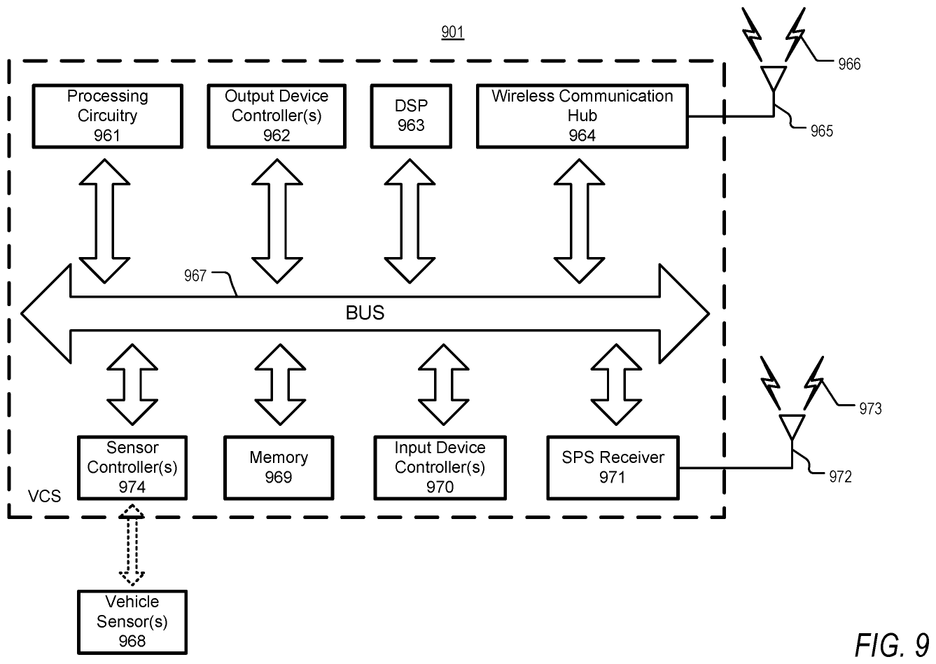

In order to operate accurately and with precision, the SAV 100 can be outfitted with a plurality of vehicle sensors 105, including, among others, one or more cameras 106, one or more surround view cameras 107, at least one radar (radio detection and ranging; herein “radar”) 108, at least one LiDAR (light detection and ranging; herein “lidar”) 109, at least one ultrasonic sensor 110, and one or more corner radar 111. Data acquired from the plurality of vehicle sensors 105 can be sent to a vehicle control system 101, comprising, among other components, processing circuitry(s), a storage medium, image processing circuitry(s), and communication circuitry(s), in order to be processed, locally and/or globally, and utilized in vehicle operation. In one embodiment, the vehicle control system 101 can be an electronic control unit, “electronic control unit” being used herein to describe any embedded system in automotive electronics that controls one or more electrical systems or subsystems in a vehicle, including, among others, a telematics control unit, an engine control module, and a powertrain control module. One implementation of the vehicle control system 101 is illustrated in FIG. 9. The above-described plurality of vehicle sensors 105 of the SAV 100 will be discussed in brief below.

Regarding the one or more cameras 106, the cameras may be positioned along a forward panel of the SAV 100 and arranged such that, in the case of a plurality of cameras, a parallax is created between the viewpoints. The parallax can be subsequently exploited, based upon the fixed geometric relationship between the viewpoints along the panel of the SAV 100, to determine a distance to an obstacle, impediment, vehicle charging station, charging element of a charging unit of a vehicle charging station, and the like. To this end, the one or more cameras 106 may provide mono- or stereo-scopic perspective. The one or more cameras 106 can employ, among other sensors, CMOS image sensors.

Regarding the one or more surround view cameras 107, the surround view cameras may be positioned around the SAV 100 in order to create a parallax and to obtain a 360° representation of the vehicle surroundings. As before, the parallax can be subsequently exploited, based upon the fixed geometric relationship between the viewpoints, in order to determine a distance to an obstacle, impediment, vehicle charging station, charging element of a vehicle charging station, and the like. The one or more surround view cameras 107 can employ, among other sensors, CMOS image sensors.

Regarding the above-described one or more cameras 106 and one or more surround view cameras 107, in addition to distancing, the output of the cameras 106, 107 can be further processed by the vehicle control system 101 to detect and identify the vehicle surroundings. For instance, the image processing circuitry(s) of the vehicle control system 101 can perform one or more image classification operations and/or image segmentation operations on an output of the cameras 106, 107 in order to identify a vehicle charging station identifier, a location of a vehicle charging station, a type and location of a charging unit of the vehicle charging station, and/or a location and number of charging units at a vehicle charging station.

Regarding the at least one radar 108, the radar may be positioned along a forward panel of the SAV 100. The at least one radar 108 can be one selected from a group of radars including, among others, short range radar, medium range radar, and long range radar. In an embodiment, and as employed commonly in Adaptive Cruise Control and Automatic Emergency Braking Systems, the at least one radar 108 may be a long range radar with an operational range of, for example, a few hundred meters. The at least one radar 108 may be used to measure a distance between the SAV 100 and a preceding obstacle, impediment, vehicle charging station, charging element of a vehicle charging station, and the like, and may be used to detect and identify objects within an external environment of the SAV 100.

Regarding the at least one lidar 109, the lidar may be positioned, for example, at a forward facing position and/or at a position with a 360° viewpoint. The at least one lidar 109 can be an infrared lidar system using a rotating laser via a micro-electro-mechanical system, a solid-state lidar, or any other type of lidar. In one embodiment, the at least one lidar 109 can provide a 105 nm wavelength with up to a 300 meter operational range.

In an embodiment, radar and lidar may be interchangeable, mutatis mutandis, for certain distancing applications.

Regarding the at least one ultrasonic sensor 110, the ultrasonic sensor may be disposed at corners of the SAV 100 for, in particular, short-range distancing and scene mapping. The at least one ultrasonic sensor 110 can be an ultrasonic sensor having asymmetric directivity (110°×50°), short ringing time and high sound pressure, sensitivity and reliability, and be configured to produce, among others, a 40 kHz, 48 kHz, 58 kHz, or 68 kHz nominal frequency as required by the current situation.

Regarding the one or more corner radars 111, the radars can be substantially similar to the above-described at least one radar 108. Deployed as corner radars, the one or more corner radars 111 can be short range radar or medium range radar, as demanded, and can be broadband Frequency Modulated Continuous Wave radar.

In an embodiment, a combination of longitudinally-acquired (time-based) data from the above-described camera and distancing systems (radar and/or lidar, front cameras, ultrasonic) can be used to extract outlines of obstacles, moving objects, a vehicle charging station, a charging element of a vehicle charging station, and the like.

Of course, it can be appreciated by one of ordinary skill in the art that the above-described plurality of sensors 105 do not constitute an exhaustive list and are merely exemplary of vehicle sensors that may be found on an SAV or other vehicle. In that context, any combination of vehicle sensors, described herein or not, can be integrated in order to achieve the function of the methods described herein.

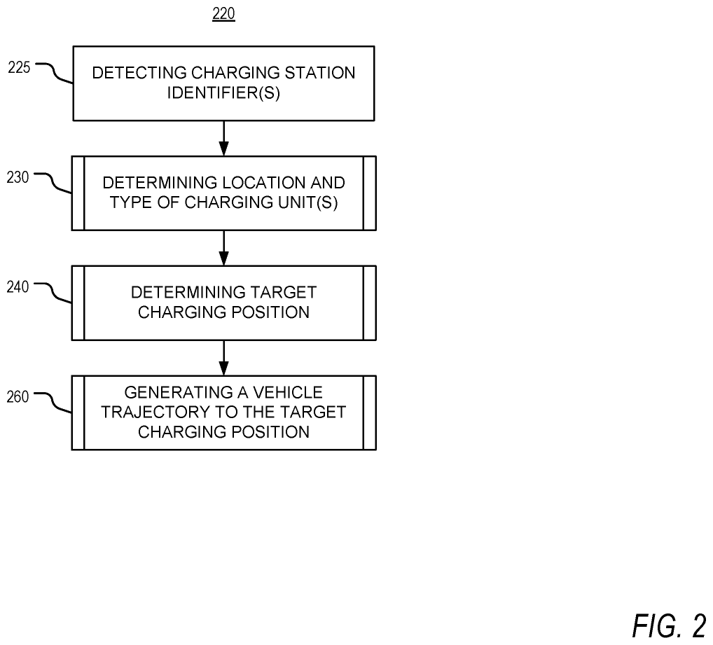

Turning now to FIG. 2, method 220 of the present disclosure will be described in view of the SAV 100 described above and the software components and hardware components described below. In an embodiment, method 220 may be performed by a VCS of an SAV. In another embodiment, method 220 may be performed by either one of a third-party device, a mobile device, a remote server, or combinations thereof, in communication with the VCS of the SAV. The third-party device may be, in an example, an imaging unit affixed to the SAV that is configured to acquire images and perform image processing such as semantic image segmentation, image classification, object detection, and object tracking, among others. The imaging unit may be further configured to communicate with the SAV to interact with the user of the SAV. The mobile device may be, in an example, a smartphone or other device that the user has to hand.

Method 220 will be described from the perspective of an SAV that is in need of a charge and has navigated to a vehicle charging station but has not been aligned with a charging element of the vehicle charging station.

Accordingly, at step 225 of method 220, one or more vehicle charging station identifiers, referred to herein interchangeably as identifiers, may be detected. The identifier(s) may be a graphical pattern or other marking that can be captured by and detected via cameras of the SAV. In an embodiment, the identifiers may convey information about the vehicle charging station, including coordinates of the vehicle charging station relative to the identifier, and a type of corresponding charging units. In an embodiment, the identifiers are merely detectable patterns or markings that are co-located with a charging position of a corresponding charging unit, the type of charging unit being as of yet unknown. The detection of the identifiers may be performed by image processing of images acquired by one or more cameras arranged on the exterior of the SAV (as described above with reference to FIG. 1). The image processing may include semantic image segmentation, object detection, and image classification, among others. The image processing may be performed by a convolutional neural network, in an example. Note that the term SAV′ and ‘vehicle’ may be used interchangeably herein to refer to the same object.

At sub process 230 of method 220, a location and a type of charging units at the vehicle charging station may be determined via application of computer vision algorithms to images including the one or more identifiers. For instance, one or more computer vision algorithms can be used to determine, from images acquired by the one or more cameras, the location and the type of charging units at the vehicle charging station.

In an embodiment, and for a given identifier, a first computer vision algorithm can be applied to images including the detected identifier in order to determine a location of the charging unit. A second computer vision algorithm can subsequently, or simultaneously in another embodiment, be applied to the images in order to determine a type of the charging unit corresponding to the identifier.

In another embodiment, the given identifier may have a unique composition indicating a location (e.g., coordinates, angulation, etc.) of the vehicle charging station and a type (e.g. wall-mounted robot charging arm, wireless charging unit, etc.) of one or more charging units supported by the vehicle charging station. In an example, the location of the vehicle charging station and the type of the one or more charging units may be discerned via comparison of the detected graphical pattern against a database of graphical patterns. The database of graphical patterns may be comprised of graphical patterns that are associated with corresponding features of vehicle charging stations. The database may be a local database or may be a remote database that is queried via wireless communication. A match between the detected graphical pattern and a graphical pattern in the database dictates the corresponding vehicle charging unit characteristics (i.e., a location and a type of charging unit). In an instance, the unique composition of the given identifier may also indicate a location of the one or more charging units supported by the vehicle charging station. In general, location of a charging unit may be provided relative to the location of the identifier, or relative to a global coordinate system. If the location of the charging unit is given relative to the location of the identifier, the processor first determines a location of the identifier relative to the vehicle, and then determines location of the charging unit relative to the vehicle using the information provided by the identifier and the determined location of the identifier.

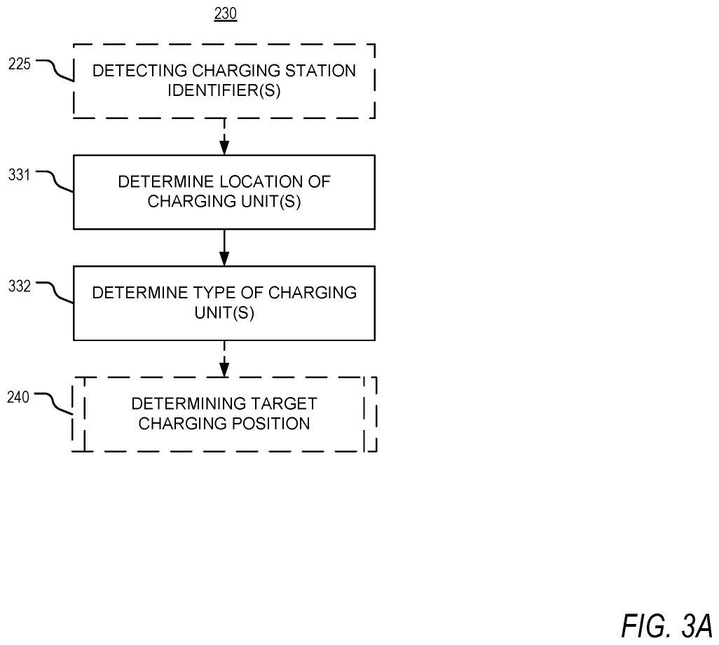

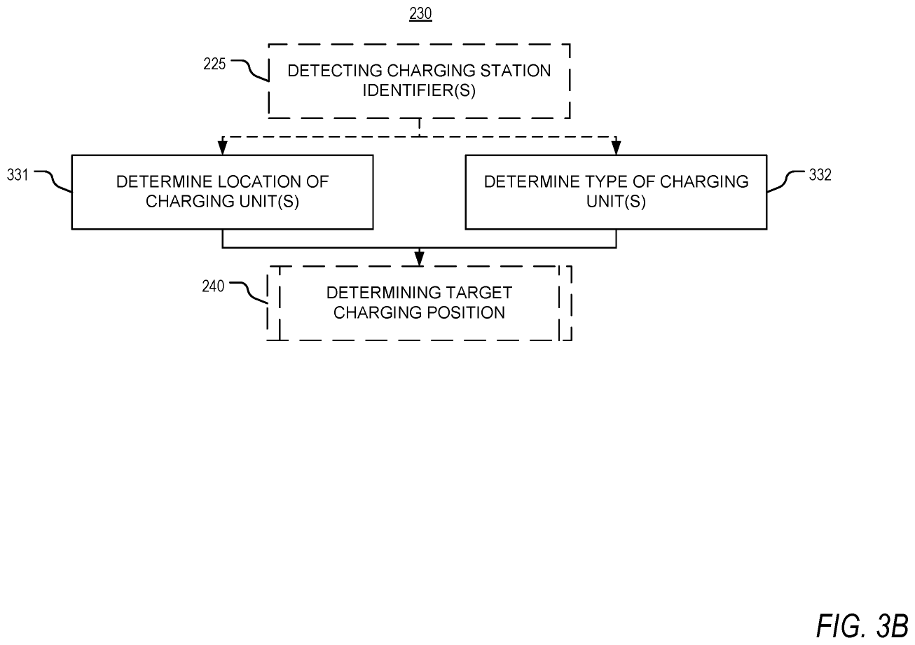

Sub process 230 of method 220 will be described in greater detail with reference to FIG. 3A and FIG. 3B. Following determination of a location and a type of one or more charging units at the vehicle charging station at sub process 230 of method 220, a target charging position can be determined at sub process 240 of method 220.

In an embodiment, the target charging position may be based on the location of the detected graphical pattern and the corresponding type of charging unit. Thus, the target charging position can then be a position co-located with the location of the detected graphical pattern. For instance, when the type of charging unit is determined to be a wireless charging unit, the target charging position may be co-located with the determined location of the detected graphical pattern as the wireless charging unit, which may be embedded within the tarmac immediately below the graphical pattern, is most effective at a closest relative position. If, in another instance, the type of charging unit is determined to be a wall-mounted robot charging arm, the target charging position may be defined as a position with a predefined distance from the robot charging arm, but may be modifiable within a range of motion allowed by the flexibility of the wall-mounted robot charging arm.

In the event only a single type of charging unit is supported by the vehicle charging station (and happens to be compatible with a charging system of the SAV), the target charging position may be immediately considered in the path planning module. In the event more than one type of charging unit is supported by the vehicle charging station, one of the charging units may be selected based on certain factors of each charging unit type, including charging efficiency, and the target charging position may correspond to a predefined distance from the determined location of the selected charging unit.

As alluded to above, a mobility of the selected charging unit can be evaluated to determine if additional alignment modifications may be made to the target charging position. For example, if the selected charging unit has a fixed charging element, the target charging position may not be adjustable, as alignment modifications would result in poor charging conditions. In another example, if the selected charging unit has a mobile charging element, the target charging position may be adjusted based on user preference within a predefined range defined by the charging unit associated with the mobile charging element.

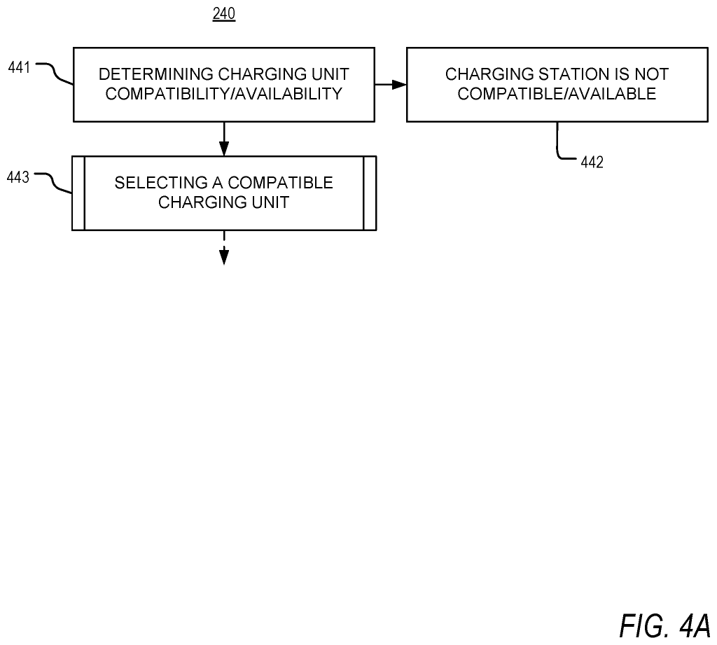

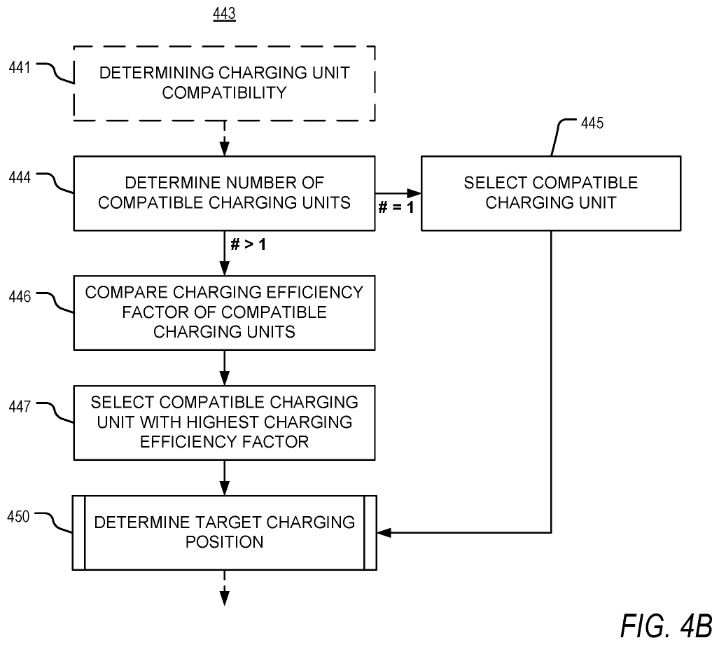

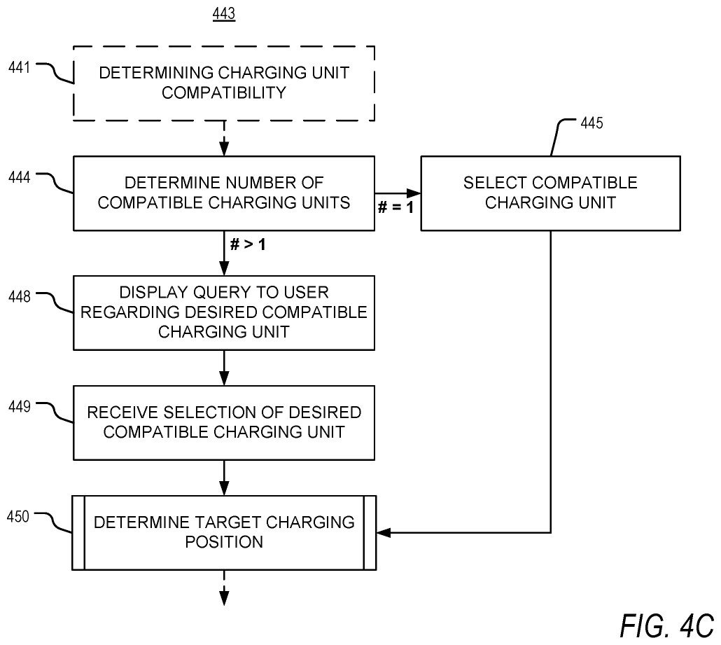

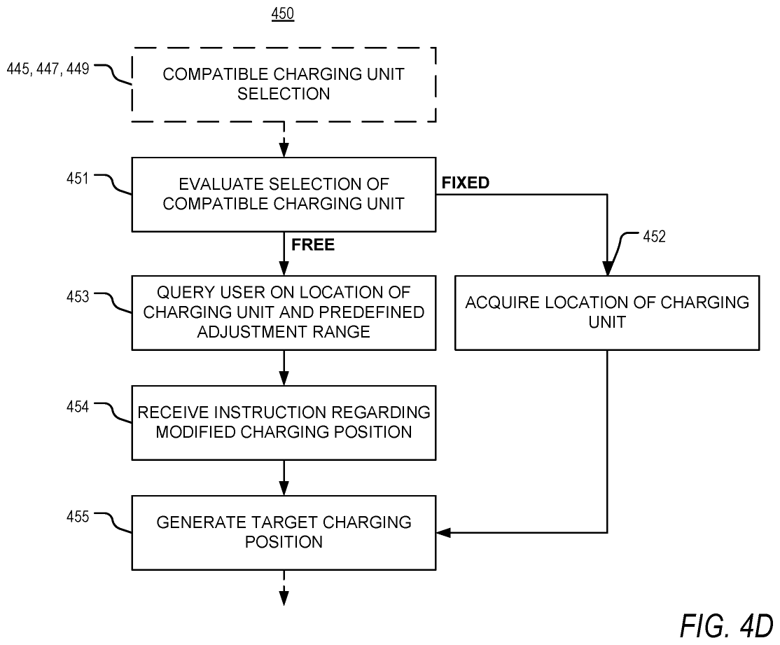

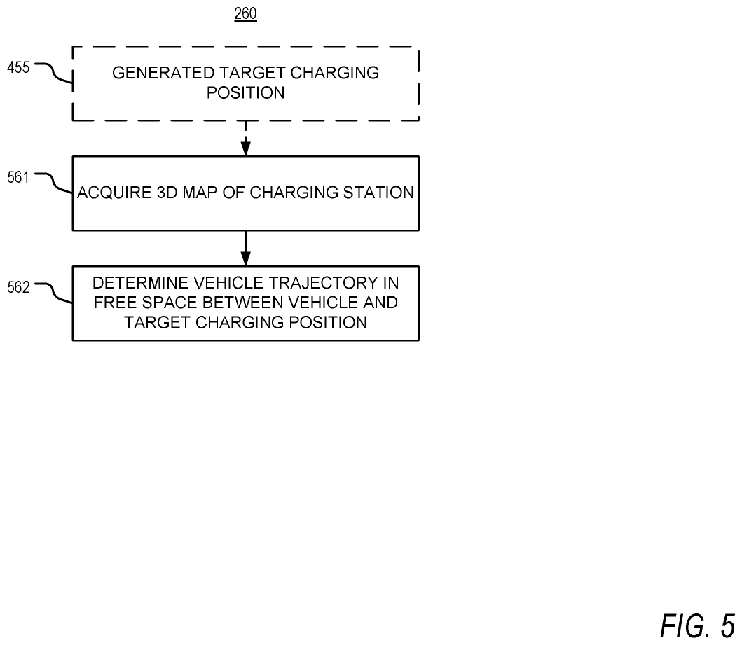

Introduced above, sub process 240 of method 220 will be described further and in detail with respect to FIG. 4A through FIG. 4D.

Now, at sub process 260 of method 220, a vehicle trajectory between a current position of the vehicle and the determined target charging position of the vehicle can be generated.

In an embodiment, the vehicle trajectory may be generated by evaluating a 3D map of the vehicle charging station and the surrounding vehicle environment in view of the current position of the vehicle and the determined target charging position of the vehicle. The vehicle trajectory may be generated by motion planning algorithms, or path planning algorithms, and the like, that may be configured to determine a route between a start point (e.g., current position of the vehicle) and an end point (e.g., target charging position of the vehicle) while accounting for obstacles that may be present at that moment.

The vehicle trajectory may be generated by circuitry of one of the VCS, the third-party equipment, a mobile device, or the remote server, and may, subsequently, be made available to the VCS, by communication means, for optional execution of the vehicle trajectory. The optional nature of the generated vehicle trajectory, in one embodiment, separates the execution of the vehicle trajectory from the path planning and allows for, in one instance, last minute changes or abortion of the trajectory movements. For example, if obstacles appear or disappear from the external vehicle environment, a collision avoidance module may perform real time evaluations to ensure that the generated vehicle trajectory can be safely implemented. To this end, the optional nature of the generated vehicle trajectory allows the collision avoidance module of the VCS of the SAV to, in an embodiment, determine in real-time if the environmental scene surrounding the SAV allows for safe execution of the generated vehicle trajectory, understanding that the prescribed vehicle trajectory was generated without a prediction of potential obstacles that may appear over time between the current position of the SAV and the target charging position of the SAV. The environmental scene may be continuously evaluated to detect, identify, and track potential obstacles and/or other objects. The user may also, in another embodiment, intervene via the user interface of the SAV if their intentions change and it is decided that vehicle charging, or that specific type of vehicle charging, is not desired. In the event that no impediments to charging arise, the VCS of the SAV proceeds with executing the generated vehicle trajectory to maneuver the vehicle to the target charging position.

Sub process 230 of method 220 will now be described in greater detail with reference to FIG. 3A and FIG. 3B. Briefly, sub process 230 of method 220 allows for determining a location and a type of a charging unit(s) available at a vehicle charging station. In one instance, as described with reference to FIG. 3A, the location and the type of the charging unit(s) can be determined sequentially, the result of one determination being used for the determining of the other. In another instance, as described with reference to FIG. 3B, the location and the type of the charging unit(s) can be determined independently.

With reference to FIG. 3A, and assuming only a single charging unit is supported by a respective vehicle charging station, a location of the charging unit can be determined at step 331 of sub process 230 based on an associated charging station identifier detected at step 225 of method 220. Determining the location of the charging unit includes application of a first computer vision algorithm configured to, within images of the vehicle charging station, identify and determine a location of the charging station identifier. The location of the charging station identifier may be determined relative to the SAV. Subsequently, the determined location of the charging station identifier can be used identify a region of interest within the images of the vehicle charging station. The region of interest may be an area proximate the charging station identifier, as will be described herein, or may be an area of the images indicated by the charging station identifier as including the charging unit. The region of interest, which includes the charging station identifier and a corresponding charging unit, can be evaluated at step 332 of sub process 230 using a second computer vision algorithm to determine a type of the corresponding charging unit. The type of the corresponding charging unit may be identified as a wall-mounted robot charging arm, a wireless charging unit, a mobile plug-in charging unit, and the like. The location and the type of the charging unit of the vehicle charging station can then be used at sub process 240 of method 220 to determine a target charging position.

In an embodiment, and when more than one charging unit is supported by a respective vehicle charging station, locations of the charging units can be determined using a second computer vision algorithm to determine a type and a location of the charging units. The type of the corresponding charging unit may be identified as a wall-mounted robot charging arm, a wireless charging unit, a mobile plug-in charging unit, and the like. The location and the type of the charging unit of the vehicle charging station can then be used at sub process 240 of method 220 to determine a target charging position.

As indicated above, the location and the type of the charging unit may be determined simultaneously or independently. To this end, as shown in FIG. 3B, the determining the location of charging unit at step 331 of sub process 230 and the determining the type of charging unit at step 332 of sub process 230 may be performed using a same set of images of the vehicle charging station and without any identification of a region of interest. At step 331 of sub process 230, and assuming only a single charging unit is supported by a respective vehicle charging station, the determining the location of the charging unit includes application of a first computer vision algorithm configured to, within the images of the vehicle charging station, identify and determine a location of the charging station identifier. The location of the charging station identifier may be determined relative to the SAV. Concurrently, the determining the type of charging unit includes application of a second computer vision algorithm, at step 332 of sub process 230, to identify and determine a type of the charging unit. The type of the charging unit may be identified as a wall-mounted robot charging arm, a wireless charging unit, a mobile-mounted plug-in charging unit, and the like.

In an embodiment, the first computer vision algorithm and the second computer vision algorithm can be one of a number of computer vision algorithms adaptable to the tasks described herein. For instance, the computer vision algorithms may be one of an image classification algorithm, an object detection algorithm, an object tracking algorithm, a semantic segmentation algorithm, an instance segmentation algorithm, and the like.

In an embodiment, the first computer vision algorithm may be a semantic segmentation algorithm, an object detection algorithm, an image classification algorithm, or a combination thereof. The object detection algorithm may be a region-based convolutional neural network (R-CNN). The object detection may include Selective Search, a convolutional neural network, and a support vector machine. Selective Search may include an approach that uses a sliding window of different size to locate objects in an image and segmentation to separate objects of different shapes in the image by assigning them different colors. The semantic segmentation algorithm may be a fully-connected convolutional neural network that provides pixel-wise predictions. The instance segmentation algorithm may be a mask R-CNN, which includes an additional branch of a Faster R-CNN that outputs a binary mask that says whether or not a given pixel is part of an object. In an example, the first computer vision algorithm may be an object detection algorithm that detects and locates identifiers of a vehicle charging station.

In an embodiment, the second computer vision algorithm may be a semantic segmentation algorithm, an object detection algorithm, an image classification algorithm, or a combination thereof. The object detection algorithm may be a R-CNN. The object detection may include Selective Search, a convolutional neural network, and a support vector machine. Selective Search may include an approach that uses a sliding window of different size to locate objects in an image and segmentation to separate objects of different shapes in the image by assigning them different colors. The semantic segmentation algorithm may be a fully-connected convolutional neural network that provides pixel-wise predictions. The instance segmentation algorithm may be a mask R-CNN, which includes an additional branch of a Faster R-CNN that outputs a binary mask that says whether or not a given pixel is part of an object. In an example, the second computer vision algorithm may be an object detection algorithm that detects and identifies a type of a charging unit supported by the vehicle charging station.

Returning now briefly to FIG. 3A and FIG. 3B, the output of either manifestation of sub process 230 of method 220 (i.e., location and type of charging unit) can be provided to sub process 240 of method 220 and a target charging position of the SAV can be determined.

With reference now to FIG. 4A through FIG. 4D, sub process 240 of method 220 will be described.

At step 441 of sub process 240, a charging unit(s) supported by the vehicle charging station is evaluated to determine availability and compatibility with a charging system(s) of the SAV. The charging system(s) of the SAV may include one or more charging elements. For instance, the charging system(s) may include a wireless charging subsystem and a conductive charging subsystem. The one or more charging elements may include inductive charging elements (e.g. wireless charging) and conductive charging elements (e.g. plug in charging). To this end, a type of a charging unit(s) supported by the vehicle charging station, as determined in sub process 230 of method 220, can be compared with the charging system(s) of the SAV to determine compatibility. Moreover, in an embodiment, step 441 of sub process 240 may also include determining an availability of a vehicle charging station by further processing the acquired images of the vehicle charging station in order to determine if the charging unit(s) supported by the vehicle charging station is already in use.

If it is determined at step 441 of sub process 240 that the vehicle charging station does not support a charging unit(s) compatible with the charging system(s) of the SAV, or does not have an available, compatible charging unit(s), sub process 240 proceeds to step 442 and method 220 is ended.

If, alternatively, it is determined that at least one charging unit supported by the vehicle charging station is available and compatible, sub process 240 proceeds to sub process 443 and one of the available and compatible at least one charging unit supported by the vehicle charging station can be selected. For instance, it may be that both of the vehicle and the vehicle charging station are compatible with wireless charging elements and plug in charging elements (e.g., wall-mounted robot charging arm, mobile-mounted plug-in charging unit, etc.). Thus, one of the charging elements, or one of the charging units, will need to be selected. Sub process 443 of sub process 230 will be described in greater detail with respect to FIG. 4B and FIG. 4C.

Accordingly, with reference now to FIG. 4B and FIG. 4C, one of the at least one compatible, available charging units can be selected for charging. In one embodiment, the selection process is performed by processing circuitry of the VCS of the SAV, the third-party device, a mobile device, or the remote server, as appropriate. In another embodiment, the selection process is performed by the user of the SAV via one or more of the above.

FIG. 4B provides a flow diagram of circuitry-based selection of a charging unit. At step 444 of sub process 443, a number of the compatible, available charging unit(s) determined at step 441 of sub process 240 can be determined. If it is determined that a number of possible charging unit(s) is only 1, sub process 443 proceeds to step 445 and the single possible charging unit is selected for subsequent processing. If, however, it is determined at step 444 of sub process 443 that more than one charging unit is compatible and available, sub process 443 proceeds to step 446 in order to select between the more than one charging unit.

At step 446 of sub process 443, each of the more than one charging unit is evaluated to determine which provides a desired charging functionality to the SAV. The evaluation can be a comparison of certain factors indicative of how well energy may be transferred between the charging unit and the vehicle. In an embodiment, the comparison may be of a charging efficiency factor that is specific to each type of charging unit being considered, the charging efficiency factor reflecting an amount of energy that can be transferred to the SAV per unit time. For instance, a wall-mounted robot arm charging unit may have a higher charging efficiency factor than a wireless energy transfer charging unit. Of course, other comparisons may be performed and may be based on the type of charging unit, generally, or the type of compatible, available charging unit(s) in view of specific components and other constraints specific to the SAV to be charged.

Based on the comparison at step 446 of sub process 443, the charging unit with the highest charging efficiency factor, in an example, can be selected at step 447 of sub process 443.

At sub process 450 of sub process 443, the selected one of the compatible, available charging unit(s), from either step 445 or step 447, can be used to generate a target charging position of the vehicle. To this end, sub process 450 of sub process 443 will be described in greater detail with reference to FIG. 4D.

While the flow diagram of FIG. 4B describes a scenario wherein the VCS, third-party device, a mobile device, or remote server, as appropriate, selects the charging unit to be used, FIG. 4C describes a scenario wherein the user of the vehicle selects the desired charging unit.

At step 444 of sub process 443 of FIG. 4C, a number of the compatible, available charging unit(s) determined at step 441 of sub process 240 can be determined. If it is determined that a number of possible charging unit(s) is only 1, sub process 443 proceeds to step 445 and the single possible charging unit is selected for subsequent processing. In this event, the user may have an opportunity, at a later time, to confirm and/or reject the single possible charging mechanism. If, however, it is determined at step 444 of sub process 443 that more than one charging unit is compatible and available, sub process 443 proceeds to step 448 in order for a selection between the more than one charging units to be made.

At step 448 of sub process 443, each of the more than one charging units are communicated to the user of the SAV via a user interface, which may be tactile, auditory, or visual, among others. For instance, the communication may be via audio or visual graphics and may exploit a touch screen user interface wherein the user can interact with the SAV via the same or different modalities. In an embodiment, the communication may be a visual graphic displayed via a display (i.e. touch screen display) of the vehicle and may indicate the number and respective type of possible charging units. The display may also indicate corresponding charging efficiency factors, as described above. In another embodiment, the display may indicate different target charging positions of the vehicle. For instance, it may be the case that, for a wireless charging unit, the vehicle needs to be maneuvered for forward perpendicular parking while, for a robot charging arm, the vehicle needs to be maneuvered for backward perpendicular parking. Based on the display of step 448 of sub process 443, a user selection may be received via the user interface at step 449 of sub process 443. For instance, the driver may prefer to perform a backward perpendicular parking maneuver and may indicate so via the user interface.

At sub process 450 of sub process 443, the selected one of the compatible, available charging unit(s), from either step 445 or step 449, can be used to generate a target charging position of the vehicle. To this end, sub process 450 of sub process 443 will now be described in greater detail with reference to FIG. 4D.

FIG. 4D is a flow diagram of sub process 450 of sub process 443, as described in both FIG. 4B and FIG. 4C, wherein a target charging position of the vehicle to be charged is determined based on the selected one of the possible charging units.

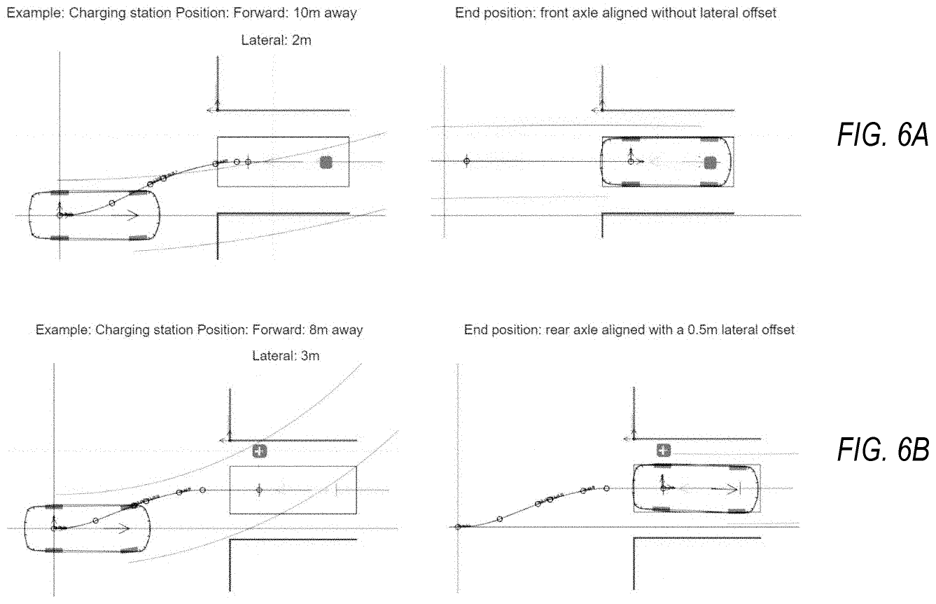

At step 451 of sub process 450, and upon receiving the selected charging unit from either of steps 445, 447, or 449 of FIG. 4B or FIG. 4C, the selection is evaluated in view of a corresponding type of the selected charging unit. If it is determined that the type of selected charging unit includes a fixed charging element (e.g., a wireless charging pad, etc.), as in FIG. 6A, then sub process 450 of sub process 443 proceeds to step 452 and the location of the charging unit, determined at step 331 of sub process 230 according to the determined location of the identifier, is acquired to be used as the target charging position. Accordingly, at step 455 of sub process 450, the target charging position is generated. If, however, it is determined that the type of selected charging unit includes a mobile charging element (e.g., a wall-mounted robot arm charging unit, a mobile-mounted plug-in charging unit, etc.), as in FIG. 6B, sub process 450 proceeds to step 453 and the user is queried regarding possible adjustments to a target charging position.

At step 453 of sub process 450, the user may be queried to evaluate a location of the charging unit, determined at step 331 of sub process 230, in view of a predefined adjustment range associated with the type of charging unit. The query may be made via a display of a user interface of the vehicle. The query may be an image of the vehicle charging station with an overlaid image of the vehicle in a possible charging position corresponding to the determined location of the charging unit.

As generalized in FIG. 6B, the image may reflect the vehicle in a charging bay of the vehicle charging station. The image of the vehicle charging station may be a stored image of the vehicle charging station acquired from local memory or from remote memory or may be based on real-time image processing of acquired images of the vehicle charging station. The displayed query may include dimensions and reference distances so that a decision regarding a target charging position of the vehicle can be made.

In an embodiment, the displayed query may indicate that a possible charging position of the vehicle is in close proximity to a wall on the left side of the vehicle. Accordingly, the charging position would make it difficult for the user to exit the vehicle during the charging operation. Of course, because the charging element of the selected charging unit is a mobile charging element, the charging position of the vehicle may be adjusted according to the predefined adjust range associated with the particular type of charging unit, the predefined adjustment range being a range of movement corresponding to a minimum and a maximum range of motion of a charging element of the selected charging unit. For instance, the adjustment may be a lateral movement of the vehicle away from the wall. Accordingly, the user may virtually manipulate the charging position of the vehicle on the display of the user interface until a desired position of the vehicle is reached.

A result of the user interaction with the user interface responsive to the displayed query can be communicated and received by the VCS of the SAV, the third-party device, a mobile device, or the remote server, as appropriate, at step 454 of sub process 450. The received instruction from the user indicates a requested charging position of the vehicle. The requested charging position of the vehicle, if acceptable, may be a target charging position generated at step 455 of sub process 450.

Having generated the target charging position at sub process 450, method 220 proceeds to sub process 260 and a vehicle trajectory between a current position of the SAV and the target charging position of the SAV at the vehicle charging station can be determined.

At step 561 of sub process 260, a 3D map of the vehicle charging station is acquired. The 3D map may be a stored 3D map of the vehicle charging station, that is stored locally or is remotely stored and accessible in real-time, or may be a 3D map that is generated based on images, and other vehicle sensor data, acquired in real-time by image sensors of the vehicle.

At step 562 of sub process 260, the 3D map of the vehicle charging station, in combination with the current position of the vehicle and the target charging position of the vehicle, can be used to determine the vehicle trajectory in free space between the vehicle and the target charging position. The vehicle trajectory may be generated by a path planning algorithm such as a Voronoi diagram algorithm, an occupancy grid algorithm, a cost map algorithm, a state lattice algorithm, a driving corridor algorithm, and combinations thereof. Path planning includes finding a geometric path between the current position of the vehicle and the target charging position of the vehicle so that each position of the vehicle along the path is feasible. As implemented in vehicle trajectory generation, path planning includes real-time planning of vehicle movements between feasible states, satisfying kinematic limits of the vehicle based on dynamics and as constrained by the navigation mode.

In an embodiment, the determined vehicle trajectory may be similar to that shown in FIG. 6A and FIG. 6B, wherein a smooth path is planned and may be executed by the VCS of the SAV, if safe and appropriate.

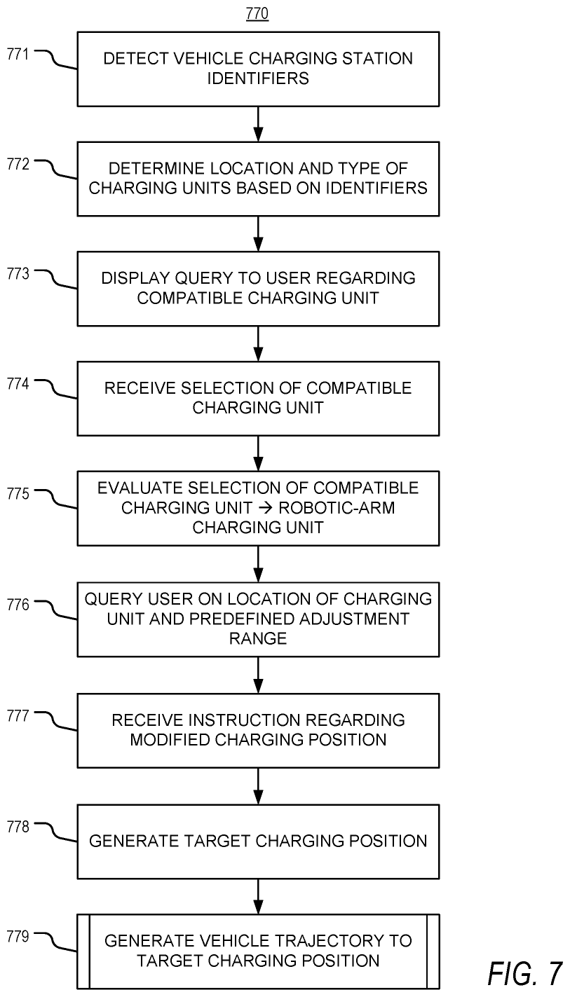

While described in detail with varied embodiments, above, methods of the present disclosure will now be described with respect to an exemplary implementation with reference to FIG. 7. Method 770 of FIG. 7 can be performed by the VCS of the SAV, the third-party device, a mobile device, or the remote server, as appropriate. Method 770 can be performed when a vehicle to be charged is approaching a vehicle charging station.

At step 771 of method 770 of FIG. 7, vehicle charging station identifiers can be detected from an image(s) of the vehicle charging station acquired by an imaging sensor(s) of the vehicle. The imaging sensor may be a camera, in an example, and the detection may be performed by object recognition methods. In an example, two identifiers are detected.

At step 772 of method 770, a location and a type of charging units corresponding to each of the identifiers can be determined by computer vision algorithms.

Subsequently, a charging system(s) of the vehicle may be evaluated with respect to the types of charging units supported by the vehicle charging station to determine compatibility. The charging system(s) of the vehicle may include a wireless charging element located on an undercarriage of the vehicle and a conductive charging element (i.e., plug in charging element) on a right side of the vehicle. It may be determined the two types of charging units supported by the vehicle charging station are both of a wireless charging unit and a conductive charging unit.

Accordingly, at step 773 of method 770, a user of the vehicle may be queried to provide instruction regarding which type of charging unit is to be used to charge the vehicle. The query may include presentation of a charge efficiency factor, as described above, for each of the compatible charging unit types. In an example, the user provides an instruction selecting the conductive charging element, which corresponds to a wall-mounted robot charging arm.

After receiving the user selection of the type of charging unit at step 774 of method 770, method 770 proceeds to step 775, wherein the selected type of charging unit is evaluated to determine a mobility of a respective charging element. As the selected type of charging unit is the wall-mounted robot charging arm unit, it is determined that the charging element is a mobile charging element and, thus, the user is queried at step 776 of method 770 to determine if adjustments are to be made to a charging position. The query may include an indication of a location of the identifier as the charging position and a predefined adjustment range that considers the mobility of the robot arm charging element.

At step 777 of method 770, instructions are received from the user via the user interface of the vehicle regarding adjustments to the charging position and in view of the predefined range of motion of the robotic charging arm. In an example, the user instruction indicates the location of the associated identifier, and corresponding charging position, are acceptable.

At step 778 of method 770, the location of the associated identifier can be used to generate the target charging position.

Accordingly, at sub process 779 of method 770, a vehicle trajectory for maneuvering the vehicle between a current position of the vehicle and the final charging position of the vehicle is generated. The target charging position may be provided directly to a VCS of an SAV in order to be performed when determined to be safe in view of any collision hazards.

In an embodiment, the above-described methods can be implemented on local hardware and/or via communication with remote hardware. Image processing tasks may be performed on local processing circuitry of the vehicle control system of the SAV and/or by wireless communication with remote circuitry, such as servers.

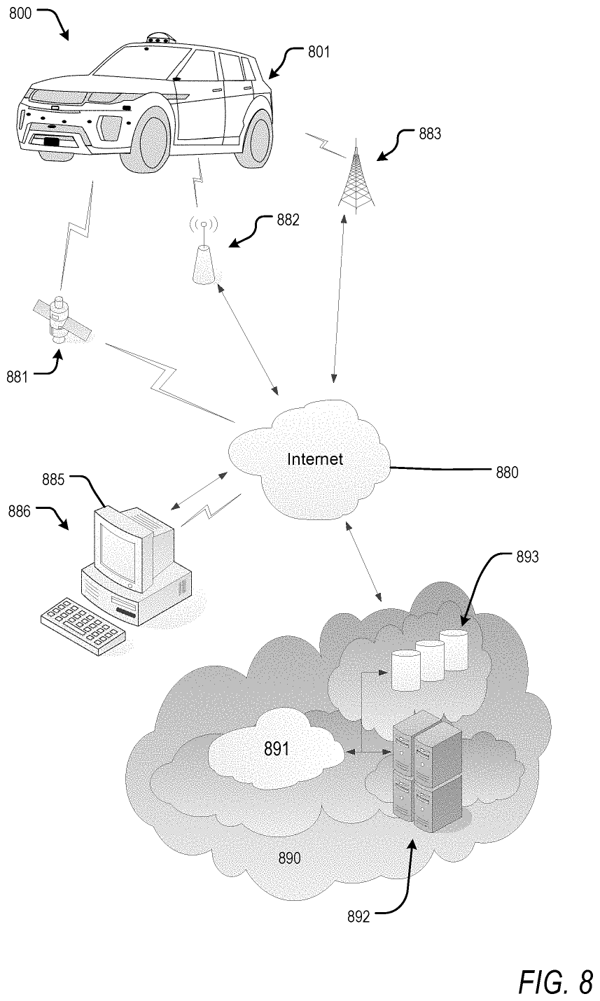

To this end, FIG. 8 illustrates an exemplary Internet-based system, wherein SAVs are connected to a cloud-computing environment, and a remote terminal, via waypoints that are connected to the Internet.

According to an embodiment, an SAV 800 having a vehicle control system 801 can connect to the Internet 880, via a wireless communication hub, through a wireless communication channel such as a base station 883 (e.g., an Edge, 3G, 4G, or LTE Network), an access point 882 (e.g., a femto cell or Wi-Fi network), or a satellite connection 881. A cloud-computing controller 891 in concert with a cloud-computing processing center 892 can permit access to a data storage center 893. The data storage center 893 may contain a braking table database that may be accessed and/or downloaded by the SAV 800. The data storage center 893 may also be updated via a remote terminal 885. The cloud-computing processing center 892 can be a computer cluster, a data center, a main frame computer, or a server farm. In one implementation, the cloud-computing processing center 892 and data storage center 893 are collocated.

In an embodiment, raw and/or processed information from a plurality of vehicle sensors can be transmitted to the cloud-computing environment 890 for processing by the cloud-computing processing center 892 and/or storage in the data storage center 893. In the case of raw information, the cloud-computing processing center 892 can perform processing similar to that performed by the vehicle control system 801 of the SAV 800 during SAV operation. These processes include, among other processes, object identification and image classification.

According to an embodiment, a remote operator 886 can access the cloud-computing environment 890 through a remote terminal 885, such as a desktop or laptop computer or workstation that is connected to the Internet 880 via a wired network connection or a wireless network connection, in order to update information related to vehicle charging stations and vehicle charging station identifiers, the updated information being accessible and/or downloadable by the SAV 800.

FIG. 9 is a block diagram of internal components of an example of a vehicle control system (VCS) that may be implemented, according to an embodiment. As discussed above, the VCS may be an electronics control unit (ECU). For instance, VCS 901 may represent an implementation of a telematics and GPS ECU, a video ECU, or by an ECU using either vehicle odometry signals or visual odometry via cameras. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations.

The VCS 901 is shown comprising hardware elements that can be electrically coupled via a BUS 967 (or may otherwise be in communication, as appropriate). The hardware elements may include processing circuitry 961 which can include without limitation one or more processors, one or more special-purpose processors (such as digital signal processing (DSP) chips, graphics acceleration processors, application specific integrated circuits (ASICs), and/or the like), and/or other processing structure or means. The above-described processors can be specially-programmed to perform operations including, among others, image processing and data processing. Some embodiments may have a separate DSP 963, depending on desired functionality. The VCS 901 also can include one or more input device controllers 970, which can control without limitation an in-vehicle touch screen, a touch pad, microphone, button(s), dial(s), switch(es), and/or the like. The VCS 901 can also include one or more output device controllers 962, which can control without limitation a display, light emitting diode (LED), speakers, and/or the like.

The VCS 901 might also include a wireless communication hub 964, which can include without limitation a modem, a network card, an infrared communication device, a wireless communication device, and/or a chipset (such as a Bluetooth device, an IEEE 802.11 device, an IEEE 802.16.4 device, a WiFi device, a WiMax device, cellular communication facilities including 4G, 5G, etc.), and/or the like. The wireless communication hub 964 may permit data to be exchanged with, as described, in part, with reference to FIG. 8, a network, wireless access points, other computer systems, and/or any other electronic devices described herein. The communication can be carried out via one or more wireless communication antenna(s) 965 that send and/or receive wireless signals 966.

Depending on desired functionality, the wireless communication hub 964 can include separate transceivers to communicate with base transceiver stations (e.g., base stations of a cellular network) and/or access point(s). These different data networks can include various network types. Additionally, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may employ LTE, LTE Advanced, and so on, including 4G and 5G technologies.

The VCS 901 can further include sensor controller(s) 974. Such controllers can control, without limitation, the plurality of vehicle sensors 968, including, among others, one or more accelerometer(s), gyroscope(s), camera(s), RADAR(s), LiDAR(s), Ultrasonic sensor(s), magnetometer(s), altimeter(s), microphone(s), proximity sensor(s), light sensor(s), and the like.

Embodiments of the VCS 901 may also include a Satellite Positioning System (SPS) receiver 971 capable of receiving signals 973 from one or more SPS satellites using an SPS antenna 972. The SPS receiver 971 can extract a position of the device, using conventional techniques, from satellites of an SPS system, such as a global navigation satellite system (GNSS) (e.g., GPS), Galileo, Glonass, Compass, Quasi-Zenith Satellite System (QZSS) over Japan, Indian Regional Navigational Satellite System (IRNSS) over India, Beidou over China, and/or the like. Moreover, the SPS receiver 971 can be used various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

In an embodiment, the SPS receiver 971 of the VCS 901 may be provided as a query to a weather forecasting service (e.g., a meteorological service) in order to obtain a current weather condition in the environment surrounding the SAV. The query may be provided via direct communication with a weather forecasting service via Internet and/or by accessing a weather forecast stored and updated within a cloud-based storage center. Adverse weather conditions may impact the accessibility of certain charging units.

The VCS 901 may further include and/or be in communication with a memory 969. The memory 969 can include, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The memory 969 of the VCS 901 also can comprise software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods, thereby resulting in a special-purpose computer.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

The methods, apparatuses, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

According to an embodiment, the present disclosure describes a system for aligning a charging element of an SAV with a compatible charging element of a vehicle charging station. The charging element of the SAV may be one or more charging elements, such as a wireless charging element and a conductive charging element (e.g. plug in charging element).

In view of the above description, narrative descriptions of examples of implementations of the methods described herein are provided below.

### NON-LIMITING EXAMPLES

### Example 1

The vehicle is equipped with both wireless charging capability and plug-in charging capability. The vehicle approaches a vehicle charging station supporting a single charging unit. The single charging unit may be a robot charging arm (i.e., plug in station), the location and type being determined based on a corresponding identifier that is detected in images of the vehicle charging station. The type of charging unit can be used to inform the user that the vehicle is compatible with the vehicle charging station. A display of a possible charging position of the vehicle can be viewed with respect to features of the vehicle charging station. Before the user confirms the possible charging position, adjustments may be made thereto, the adjustments to the possible charging position helping to define a target charging position. The adjustments may be communicated via user interface and may be instructed in view of certain tolerances of the robot charging arm. Once the target charging position is confirmed, a vehicle trajectory for maneuvering the vehicle to the target charging position can be generated. When safe and appropriate, the VCS of the SAV may maneuver the vehicle to the target charging position according to the generated vehicle trajectory.

### Example 2

The vehicle is equipped with both wireless charging capability and plug in charging capability. The vehicle approaches a vehicle charging station supporting a single charging unit. The single charging unit may be a wireless charging system, the location and type being determined based on a corresponding identifier that is detected in images of the vehicle charging station. The position of the wireless charging pad of the wireless charging system can be associated with the location of the corresponding identifier. The user can be informed that a wireless charging system has been detected. A possible charging position of the vehicle can be displayed to the user as on top of the wireless charging pad. As wireless charging requires a very accurate alignment, the presented charging position may be used as a target charging position upon confirmation by the user. Accordingly, a vehicle trajectory will be calculated between a current position of the vehicle and the target charging position of the vehicle. When safe and appropriate, the VCS of the vehicle may maneuver the vehicle to the target charging position according to the generated vehicle trajectory, or the trajectory is displayed to the user to aid in their own maneuvering of the vehicle to the target charging position.

### Example 3

The vehicle is equipped with both wireless charging capability and plug in charging capability. The vehicle approaches a vehicle charging station supporting two charging units. The position and type of both charging units can be detected relative to the vehicle, the charging unit types being wireless charging and plug-in charging. The user can be informed via user interface about both options. The user can select which charging unit to use and to align with. Depending on the selection, the process follows one of Example 1 or Example 2, as described above.

### Example 4

The vehicle is equipped with only wireless charging capability. The vehicle approaches a vehicle charging station supporting only one charging unit type, the single charging unit type being plug in charging. As the vehicle is not equipped with plug in charging capability, the user will be informed that the charging unit of the vehicle charging station is not compatible with the charging system of the vehicle.

In addition to the above, it can be appreciated for each Example that the methods described herein allow for detection of whether the charging station is occupied by another vehicle. Of course, in this instance, no automatic alignment of the vehicle will be offered.

Obviously, numerous modifications and variations are possible in light of the above teachings. It is therefore to be understood that within the scope of the appended claims, the invention may be practiced otherwise than as specifically described herein.

Embodiments of the present disclosure may also be as set forth in the following parenthetical s.

(1) A method for aligning a vehicle to be charged relative to a vehicle charging station, comprising detecting, by a processing circuitry and within an image of the vehicle charging station, one or more identifiers corresponding to one or more charging units supported by the vehicle charging station, each charging unit comprising a different charging mechanism, determining, by the processing circuitry and using the one or more identifiers, locations of the one or more charging units relative to the vehicle, and types of the one or more charging units, determining, by the processing circuitry and based on a selection of a compatible one of the one or more charging units, a target charging position of the vehicle corresponding to the selected compatible charging unit, and generating, by the processing circuitry and based on the target charging position of the vehicle, a vehicle trajectory for maneuvering the vehicle between a current position of the vehicle and the target charging position of the vehicle.

(2) The method of (1), wherein the selection of the compatible one of the one or more charging units is performed by selecting, by the processing circuitry and when there are at least two compatible charging units, one of the at least two compatible charging units based on a charging efficiency factor of each of the at least two compatible charging units.

(3) The method of either (1) or (2), further comprising displaying, by the processing circuitry and via a display of a user interface, one or more compatible ones of the one or more charging units supported by the vehicle charging station, wherein the selection of the compatible one of the one or more charging units supported by the vehicle charging station comprises receiving, by the processing circuitry, a user selection of a charging unit.

(4) The method of any one of (1) to (3), wherein determining the locations of the one or more charging units relative to the vehicle, and the types of the one or more charging units, comprises estimating, by the processing circuitry, at least one location of the one or more charging units using a first computer vision algorithm, and estimating at least one type of the one or more charging units using the estimated at least one location and a second computer vision algorithm.

(5) The method of any one of (1) to (4), further comprising determining, by the processing circuitry, compatibility between the one or more charging units supported by the vehicle charging station and an at least one charging mechanism of the vehicle, and generating, by the processing circuitry and when it is determined there are no vehicle-compatible charging mechanisms supported by the vehicle charging station, a notification that the vehicle charging station cannot be used for charging the vehicle.

(6) The method of any one of (1) to (5), wherein the selected compatible charging unit is a robotic arm-based charging unit and the generating the vehicle trajectory includes displaying, by the processing circuitry and via a display of a user interface, an option to a user to modify, within a predefined range, coordinates of the target charging position of the vehicle, receiving, by the processing circuitry and via the user interface, an instruction from the user regarding the option to modify the coordinates of the target charging position of the vehicle, and generating, by the processing circuitry, the vehicle trajectory for maneuvering the vehicle to the modified target charging position of the vehicle.

(7) The method according to any one of (1) to (6), wherein detecting the one or more identifiers comprises detecting one or more graphical patterns disposed on the vehicle charging station, coordinates of the one or more graphical patterns, and angulations of the one or more graphical patterns.

(8) The method according to any one of (1) to (7), further comprising acquiring, by the processing circuitry and via one or more cameras arranged on an exterior of the vehicle, the image of the vehicle charging station.

(9) The method according to any one of (1) to (8), wherein the detecting the identifier within the image of the vehicle charging station includes applying, by the processing circuitry, a computer vision algorithm to the image of the vehicle charging station.

(10) The method according to any one of (1) to (9), wherein the vehicle trajectory is determined by acquiring, by the processing circuitry, a three-dimensional map of an environment of the vehicle charging station, and determining, by the processing circuitry and using the three-dimensional map of the environment, the vehicle trajectory in the free space between the vehicle and the charging unit.

(11) A non-transitory computer-readable storage medium storing computer-readable instructions that, when executed by a computer, cause the computer to perform a method for aligning a vehicle to be charged relative to a vehicle charging station, comprising detecting, within an image of the vehicle charging station, one or more identifiers corresponding to one or more charging units supported by the vehicle charging station, each charging unit comprising a different charging mechanism, determining, using the one or more identifiers, locations of the one or more charging units relative to the vehicle, and types of the one or more charging units, determining, based on a selection of a compatible one of the one or more charging units, a target charging position of the vehicle corresponding to the selected compatible charging unit, and generating, based on the target charging position of the vehicle, a vehicle trajectory for maneuvering the vehicle between a current position of the vehicle and the target charging position of the vehicle.

(12) The non-transitory computer-readable storage medium of (11), wherein the selection of the compatible one of the one or more charging units is performed by selecting, when there are at least two compatible charging units, one of the at least two compatible charging units based on a charging efficiency factor of each of the at least two compatible charging units.

(13) The non-transitory computer-readable storage medium of either (11) or (12), further comprising displaying, via a display of a user interface, one or more compatible ones of the one or more charging units supported by the vehicle charging station, wherein the selection of the compatible one of the one or more charging units supported by the vehicle charging station comprises receiving a user selection of a charging unit.

(14) The non-transitory computer-readable storage medium of any one of (11) to (13), wherein determining the locations of the one or more charging units relative to the vehicle, and the types of the one or more charging units, comprises estimating at least one location of the one or more charging units using a first computer vision algorithm, and estimating at least one type of the one or more charging units using the estimated at least one location and a second computer vision algorithm.

(15) The non-transitory computer-readable storage medium of any one of (11) to (14), further comprising determining compatibility between the one or more charging units supported by the vehicle charging station and an at least one charging mechanism of the vehicle, and generating, when it is determined there are no vehicle-compatible charging mechanisms supported by the vehicle charging station, a notification that the vehicle charging station cannot be used for charging the vehicle.

(16) The non-transitory computer-readable storage medium of any one of (11) to (15), wherein the selected compatible charging unit is a robotic arm-based charging unit and the generating the vehicle trajectory includes displaying, via a display of a user interface, an option to a user to modify, within a predefined range, coordinates of the target charging position of the vehicle, receiving, via the user interface, an instruction from the user regarding the option to modify the coordinates of the target charging position of the vehicle, and generating the vehicle trajectory for maneuvering the vehicle to the modified target charging position of the vehicle.

(17) The non-transitory computer-readable storage medium according to any one of (11) to (16), wherein detecting the one or more identifiers comprises detecting one or more graphical patterns disposed on the vehicle charging station, coordinates of the one or more graphical patterns, and angulations of the one or more graphical patterns.

(18) The non-transitory computer-readable storage medium according to any one of (11) to (17), wherein the detecting the identifier within the image of the vehicle charging station includes applying a computer vision algorithm to the image of the vehicle charging station.

(19) The non-transitory computer-readable storage medium according to any one of (11) to (18), wherein the vehicle trajectory is determined by acquiring a three-dimensional map of an environment of the vehicle charging station, and determining, using the three-dimensional map of the environment, the vehicle trajectory in the free space between the vehicle and the charging unit.

(20) An apparatus for aligning a vehicle to be charged relative to a vehicle charging station, comprising processing circuitry configured to detect, within an image of the vehicle charging station, one or more identifiers corresponding to one or more charging units supported by the vehicle charging station, each charging unit comprising a different charging mechanism, determine, using the one or more identifiers, locations of the one or more charging units relative to the vehicle, and types of the one or more charging units, determine, based on a selection of a compatible one of the one or more charging units, a target charging position of the vehicle corresponding to the selected compatible charging unit, and generate, based on the target charging position of the vehicle, a vehicle trajectory for maneuvering the vehicle between a current position of the vehicle and the target charging position of the vehicle.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A method for aligning a vehicle to be charged relative to a vehicle charging station, comprising
detecting, by a processing circuitry and within an image of the vehicle charging station, one or more identifiers corresponding to one or more charging units supported by the vehicle charging station, each charging unit comprising a different charging mechanism;
determining, by the processing circuitry and using the one or more identifiers, locations of the one or more charging units relative to the vehicle, and types of the one or more charging units;
determining, by the processing circuitry and based on a selection of a compatible one of the one or more charging units, a target charging position of the vehicle corresponding to the selected compatible charging unit; and
generating, by the processing circuitry and based on the target charging position of the vehicle, a vehicle trajectory for maneuvering the vehicle between a current position of the vehicle and the target charging position of the vehicle.

2. The method of claim 1, wherein the selection of the compatible one of the one or more charging units is performed by
selecting, by the processing circuitry and when there are at least two compatible charging units, one of the at least two compatible charging units based on a charging efficiency factor of each of the at least two compatible charging units.

3. The method of claim 1, further comprising:
displaying, by the processing circuitry and via a display of a user interface, one or more compatible ones of the one or more charging units supported by the vehicle charging station,
wherein the selection of the compatible one of the one or more charging units supported by the vehicle charging station comprises
receiving, by the processing circuitry, a user selection of a charging unit.

4. The method of claim 1, wherein determining the locations of the one or more charging units relative to the vehicle, and the types of the one or more charging units, comprises:
estimating, by the processing circuitry, at least one location of the one or more charging units using a first computer vision algorithm; and
estimating at least one type of the one or more charging units using the estimated at least one location and a second computer vision algorithm.

5. The method of claim 1, further comprising:
determining, by the processing circuitry, compatibility between the one or more charging units supported by the vehicle charging station and an at least one charging mechanism of the vehicle; and
generating, by the processing circuitry and when it is determined there are no vehicle-compatible charging mechanisms supported by the vehicle charging station, a notification that the vehicle charging station cannot be used for charging the vehicle.

6. The method of claim 1, wherein the selected compatible charging unit is a robotic arm-based charging unit and the generating the vehicle trajectory includes
displaying, by the processing circuitry and via a display of a user interface, an option to a user to modify, within a predefined range, coordinates of the target charging position of the vehicle,
receiving, by the processing circuitry and via the user interface, an instruction from the user regarding the option to modify the coordinates of the target charging position of the vehicle, and
generating, by the processing circuitry, the vehicle trajectory for maneuvering the vehicle to the modified target charging position of the vehicle.

7. The method according to claim 1, wherein detecting the one or more identifiers comprises:
detecting one or more graphical patterns disposed on the vehicle charging station, coordinates of the one or more graphical patterns, and angulations of the one or more graphical patterns.

8. The method according to claim 1, further comprising:
acquiring, by the processing circuitry and via one or more cameras arranged on an exterior of the vehicle, the image of the vehicle charging station.

9. The method according to claim 1, wherein the detecting the identifier within the image of the vehicle charging station includes
applying, by the processing circuitry, a computer vision algorithm to the image of the vehicle charging station.

10. The method according to claim 1, wherein the vehicle trajectory is determined by
acquiring, by the processing circuitry, a three-dimensional map of an environment of the vehicle charging station, and
determining, by the processing circuitry and using the three-dimensional map of the environment, the vehicle trajectory in the free space between the vehicle and the charging unit.

11. A non-transitory computer-readable storage medium storing computer-readable instructions that, when executed by a computer, cause the computer to perform a method for aligning a vehicle to be charged relative to a vehicle charging station, comprising:
detecting, within an image of the vehicle charging station, one or more identifiers corresponding to one or more charging units supported by the vehicle charging station, each charging unit comprising a different charging mechanism;
determining, using the one or more identifiers, locations of the one or more charging units relative to the vehicle, and types of the one or more charging units;
determining, based on a selection of a compatible one of the one or more charging units, a target charging position of the vehicle corresponding to the selected compatible charging unit; and
generating, based on the target charging position of the vehicle, a vehicle trajectory for maneuvering the vehicle between a current position of the vehicle and the target charging position of the vehicle.

12. The non-transitory computer-readable storage medium of claim 11, wherein the selection of the compatible one of the one or more charging units is performed by
selecting, when there are at least two compatible charging units, one of the at least two compatible charging units based on a charging efficiency factor of each of the at least two compatible charging units.

13. The non-transitory computer-readable storage medium of claim 11, further comprising:
displaying, via a display of a user interface, one or more compatible ones of the one or more charging units supported by the vehicle charging station,
wherein the selection of the compatible one of the one or more charging units supported by the vehicle charging station comprises
receiving a user selection of a charging unit.

14. The non-transitory computer-readable storage medium of claim 13, wherein determining the locations of the one or more charging units relative to the vehicle, and the types of the one or more charging units, comprises:
estimating at least one location of the one or more charging units using a first computer vision algorithm; and
estimating at least one type of the one or more charging units using the estimated at least one location and a second computer vision algorithm.

15. The non-transitory computer-readable storage medium of claim 11, further comprising:
determining compatibility between the one or more charging units supported by the vehicle charging station and an at least one charging mechanism of the vehicle; and
generating, when it is determined there are no vehicle-compatible charging mechanisms supported by the vehicle charging station, a notification that the vehicle charging station cannot be used for charging the vehicle.

16. The non-transitory computer-readable storage medium of claim 11, wherein the selected compatible charging unit is a robotic arm-based charging unit and the generating the vehicle trajectory includes
displaying, via a display of a user interface, an option to a user to modify, within a predefined range, coordinates of the target charging position of the vehicle,
receiving, via the user interface, an instruction from the user regarding the option to modify the coordinates of the target charging position of the vehicle, and
generating the vehicle trajectory for maneuvering the vehicle to the modified target charging position of the vehicle.

17. The non-transitory computer-readable storage medium according to claim 11, wherein detecting the one or more identifiers comprises:
detecting one or more graphical patterns disposed on the vehicle charging station, coordinates of the one or more graphical patterns, and angulations of the one or more graphical patterns.

18. The non-transitory computer-readable storage medium according to claim 11, wherein the detecting the identifier within the image of the vehicle charging station includes
applying a computer vision algorithm to the image of the vehicle charging station.

19. The non-transitory computer-readable storage medium according to claim 11, wherein the vehicle trajectory is determined by
acquiring a three-dimensional map of an environment of the vehicle charging station, and
determining, using the three-dimensional map of the environment, the vehicle trajectory in the free space between the vehicle and the charging unit.

20. An apparatus for aligning a vehicle to be charged relative to a vehicle charging station, comprising:
processing circuitry configured to
detect, within an image of the vehicle charging station, one or more identifiers corresponding to one or more charging units supported by the vehicle charging station, each charging unit comprising a different charging mechanism,
determine, using the one or more identifiers, locations of the one or more charging units relative to the vehicle, and types of the one or more charging units,
determine, based on a selection of a compatible one of the one or more charging units, a target charging position of the vehicle corresponding to the selected compatible charging unit, and
generate, based on the target charging position of the vehicle, a vehicle trajectory for maneuvering the vehicle between a current position of the vehicle and the target charging position of the vehicle.
